(19) United States
(12) Patent Application Publication
(10) Pub. No.: US 2013/0254186 A1
(43) Pub. Date: Sep. 26, 2013

(54) MOBILE DEVICE PROVIDING INFORMATION BASED ON PREDEFINED SERACH CRITERIA

(71) Applicants: Justin HangSoo Kim, Ashburn, VA (US); Hye-Gin Helen Cho, Ashburn, VA (US)

(72) Inventors: Justin HangSoo Kim, Ashburn, VA (US); Hye-Gin Helen Cho, Ashburn, VA (US)

(21) Appl. No.: 13/848,035

(22) Filed: Mar. 20, 2013

Related U.S. Application Data
(60) Provisional application No. 61/613,211, filed on Mar. 20, 2012.

(51) Int. Cl. G06F 17/30

(52) U.S. Cl. CPC G06F 17/30424
USPC 707/722

(57) ABSTRACT

A mobile device comprises of following steps of recognizing a current location, searching a database either on cue or automatically based on at lease one predetermined search criteria set, and displaying search result or automatically ask for further action or trigger into action.

### CROSS-REFERENCE TO RELATED APPLICATIONS

This application claims the benefit of U.S. Provisional Application No. 61/613,211 filed on Mar. 20, 2012, which is incorporated herein in its entirety.

### BACKGROUND OF THE INVENTION

Currently mobile computer devices have a program that recognizes current location and gives information on physical street address without other additional information. Thus, it needs to provide further information based on the predefined search criteria.

### SUMMARY OF THE INVENTION

A mobile device comprises of following steps of recognizing a current location, searching a database either on cue or automatically based on at lease one predetermined search criteria set, and displaying search result or automatically ask for further action or trigger into action.

### BRIEF DESCRIPTION OF THE DRAWINGS

FIG. 1 shows an active zone and a user mobile device approaching or departing the active zone.

FIG. 2 shows a display of the mobile device within the active zone of a museum

FIG. 3 shows a display of the mobile device upon departing the active zone.

FIG. 4 shows a display of the mobile device for prompting an user interaction.

FIG. 5 shows a display of the mobile device upon departing the museum.

FIG. 6 shows a display of the mobile device within the active zone of a store.

FIG. 7 shows a display of the mobile device for prompting an user interaction.

FIG. 8 shows a display of the mobile device within the active zone of another store.

FIG. 9 shows a display of the mobile device for prompting an user interaction.

FIG. 10 shows a chart in relations with location, characteristics, public information, and tagged keywords.

### DETAILED DESCRIPTION OF THE INVENTION

Currently mobile devices such as smart phones and other tablet devices have a program that recognizes current location and gives information on physical street address without other additional information.

In order to provide the additional information, following steps are performed: first step is to recognize current location (or specified location; or surround area of current location or specified location), the second step is to search database either on cue or automatically based on predetermined multiple search criteria set by individual or group user, and third step is to display search result or automatically ask for further action or trigger into action.

Additionally, a mobile device user can set up automatic alerts or messages regarding the current location or address or place or other categories that is customizable to user's need.

For example, church—ring off, public schools—ring off; my church—ring off, service time; restaurants—best ranked, specials, review, etc; work-schedule, to do, subway—schedule, updates;

For example, when the mobile device enters specified church or all churches, it will detect street address and send message that it's a quiet zone and to turn the phone off/vibrate. It can also ask if needs to ask every time or save info to so automatically in the future without asking.

Other options are to not only send a message but automatically force the device off/silent. Then when the device leaves the defined area, phone reverts back to it's original setting whether it's silent/off/ring.

Another examples are followings: after locating current address, if the user is near a specified restaurant or business and has it set to show their specials/promotions, device provides that information on cue or without cue based on user's predetermined preferred setting.

IP address owner's or registered Google Place user's potential uses can be utilized. Business can use to advertise specials, promotions, events, restrictions, hazards, and warnings.

School/Police/HOA/public government/news media/website can use this to post warnings/hazards / alerts like severe weather alerts, crime, traffic, etc.

So, the following steps are utilized:
1. Recognize current location or address
2. Trigger into action:

a. Automatically trigger into action as predetermined
i. search database or address book or user defined location/place i.e. Museum.
ii. once found and matched, follow predefined steps
   1. turn off/silence/vibrate device then upon leaving the location, reset to previous device setting. OR ask if want to turn off/silence/vibrate device (on cue).
   2. If on cue, can ask if the user wants to save this action for this place for the future automatically.

b. Trigger into action after cue:
i. search database or address book or user defined location/place i.e, Museum, School, Hospital, business or places that designated themselves as a Silent zone on their website or google place
ii. once found and matched, follow predefined steps
   1. turn off/silence/vibrate device then upon leaving the location, reset to previous device setting.
   2. ask if want to turn off/silence/vibrate device (on cue) then upon leaving the location, reset to previous device setting.
      a. If on cue, can ask if user wants to save this action for this place for the future automatically.
3. automatically search database based on preset criteria and display i.e, crime alert, severe weather alert, blocked alert, favorite place alert, hospitals, etc
4. search databases on cue based specific saved criteria and display results without having to go through each criteria or data base separately i.e,

1. 5 star restaurants within 1 mile and display with information such as name of place, phone number, address and reviews, menu, website, specials, etc in alphabetical order or closest to current location etc

2. All Japanese restaurants within 2 miles with information such as name, phone, address, rating, website, etc in alphabetical order or closest to current location or based on rating etc

3. Pharmacies within 30 miles that are currently open with information such as name, phone number, hours, website, etc in alphabetical order or closest to current location etc

4. All Church (or denomination) within 10 miles with phone, address, service time, etc in alphabetical order or closest to current location etc

5. Apple stores within 30 miles with information such as name, phone number, hours, website, etc in alphabetical order or closest to current location etc

6. All spas with swedish massage within 30 miles with informations such as name, hours of operation, address, phone number, website, ratings, etc in alphabetical order or closest to current location or based on rating etc
a. once a place is selected, it can trigger further questions or action or do nothing i.e. call? add to favorite place? add to address book? add to a folder ie vacation plan summer 2012? create new folder then add? etc
b. If none shows up on search, then ask if user wants to change criteria? If criteria is changed ask if user wants to save new criteria?
5. Search data base with specified address or zip code or place based on specific saved criteria and display results without having to go through each criteria or data base separately i.e,

1. 5 star restaurants within 1 mile and display with information such as name of place, phone number, address and reviews, menu, website, specials, etc in alphabetical order or closest to current location etc

2. All Japanese restaurants within 2 miles with information such as name, phone, address, rating, website, etc in alphabetical order or closest to current location or based on rating etc

3. Pharmacies within 30 miles that are currently open with information such as name, phone number, hours, website, etc in alphabetical order or closest to current location etc

4. All Church (or denomination) within 10 miles with phone, address, service time, etc in alphabetical order or closest to current location etc

5. Apple stores within 30 miles with information such as name, phone number, hours, website, etc in alphabetical order or closest to current location etc

6. All spas with swedish massage within 30 miles with informations such as name, hours of operation, address, phone number, website, ratings, etc in alphabetical order or closest to current location or based on rating etc
a. once a place is selected, it can trigger further questions or action or do nothing i.e. call? add to favorite place? add to address book? add to a folder i.e, vacation plan summer 2012? create new folder then add? create event? etc
b. If none shows up on search, then ask if user wants to change criteria? If criteria is changed ask if user wants to save new criteria?

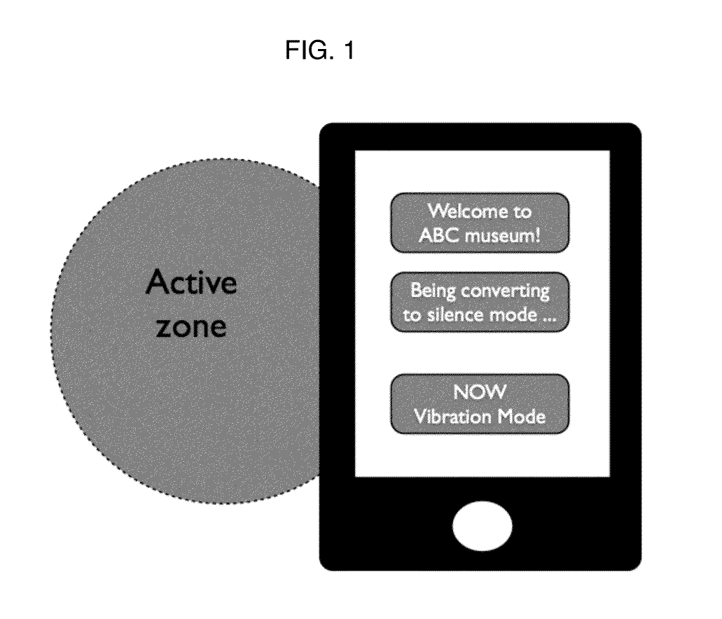

FIG. 1 shows an active zone and a mobile device approaching an active zone. The active zone is defined as a boundary line where the mobile device can actively recognize and decide a current address.

For example, when an user phone approaches around the active zone, the phone automatically reacts to show corresponding information. In addition, when the user phone gets out of the active zone, the phone automatically go back to normal mode.

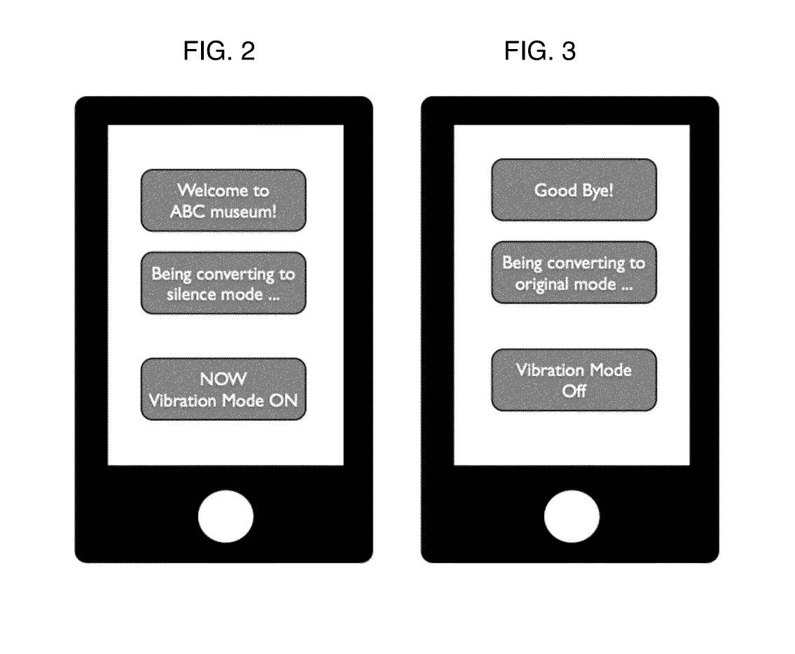

FIG. 2 shows display screen of the user device upon approaching to the active zone. For example, the user device automatically displays ABC museum's message. In addition, the device can automatically convert to vibration mode from the user device pre-existing mode. Thus, the user needs no manual conversion.

FIG. 3 shows display screen of the user device upon departing the active zone. For example, the device can show a good bye message to the user. In addition, the converted mode reverts back to the device's original setting whether it's silent/off/ring mode.

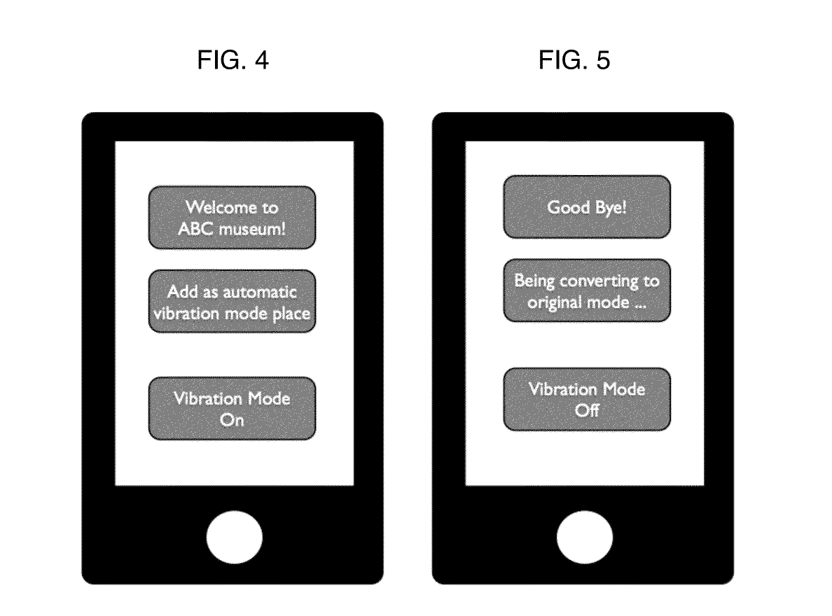

FIG. 4 shows another display screen of the user device for prompting the user to act. For example, the user can manually add ABC museum place as automatic vibration mode place. So when the user revisit the museum, the user device can automatically convert to the vibration/silence mode.

FIG. 5 shows the same display as FIG. 3 upon departing the active zone.

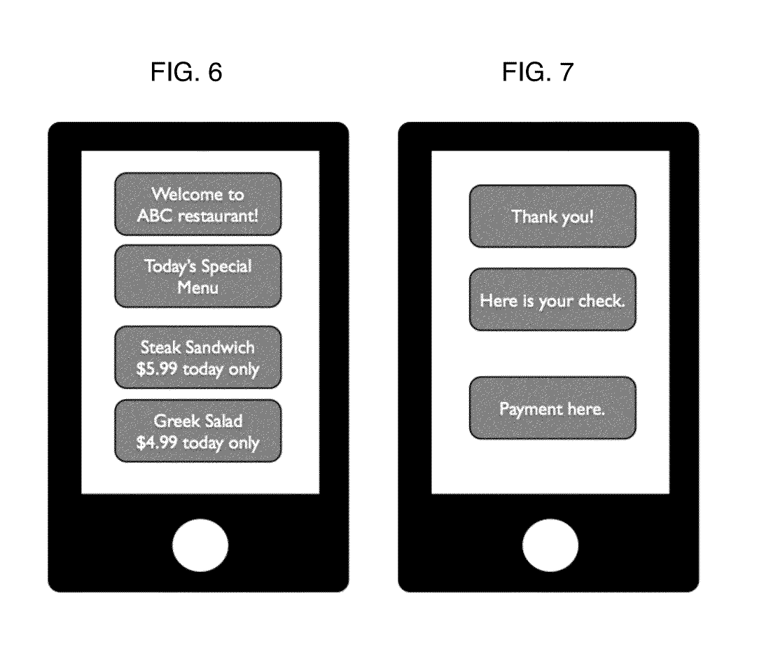

FIGS. 6-7 show an example of a restaurant. According to FIG. 6, when the user device enters into the active zone of the restaurant, it displays the restaurant's preset information such as greetings, today's special menu, and so on. Thus, the user can instantly recognize the latest restaurant information upon entering the premise or passing by the restaurant.

FIG. 7 shows a capability that the restaurant can send a message to the user directly such as check. In response, the user can pay the check on the device.

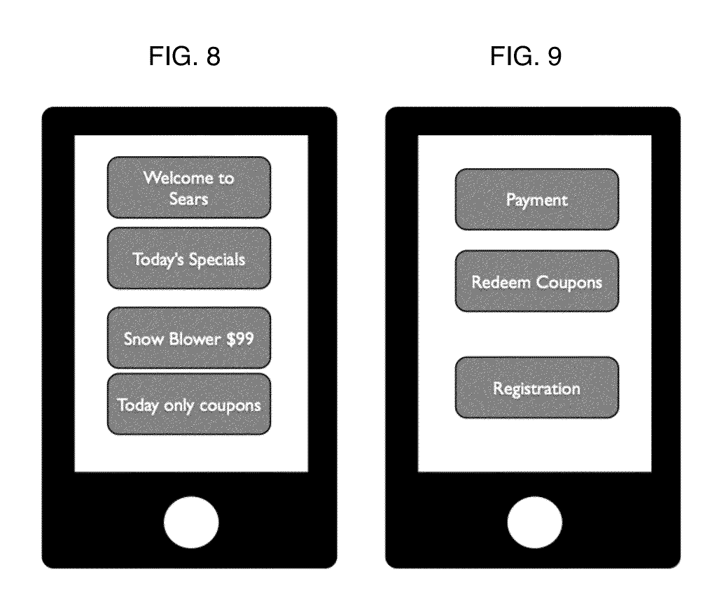

FIGS. 8-9 show an example of a department store. According to FIG. 8, the user device can display the store's special messages upon approaching and/or entering into the active zone. For example, the store can advertise today's specials, products, and coupons prompting for the user to respond.

FIG. 9 shows examples of the user interaction displays. Upon responding to the store's greetings such as pressing icons, the user enters into the store's system. Thus, the user can make payments, redeem coupons, or registrations in respond to the store system.

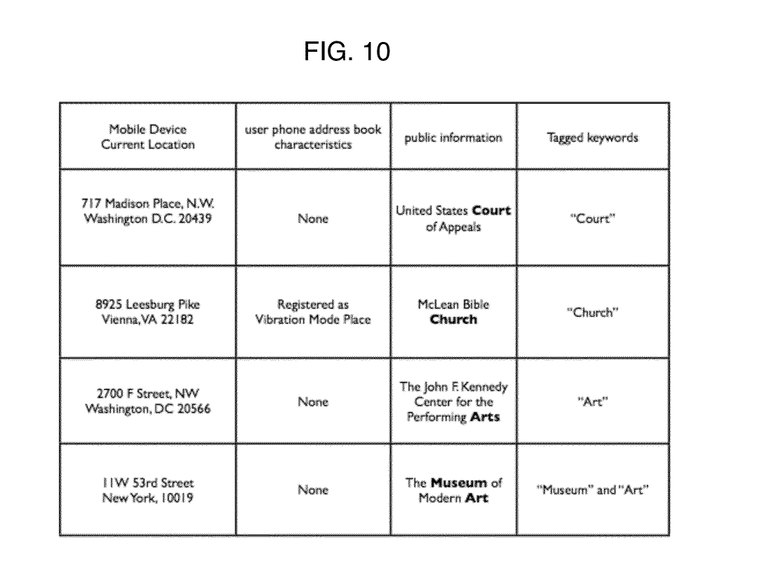

FIG. 10 show a table in which mobile device current location, user phone address book characteristics, publication information, and tagged keyword are explained with exemplified address.

For example, when the mobile device is within the active zone of the address of 717 Madison place, N.W., Washington D.C. 20439, it automatically search the address whether or not the address indicates any predefined setting. If not, prompt the user for further action. In addition, if the device can recognize both the address and pre-registered public information such as “United States Court of Appeals,” then, the device automatically scan any predefined keywords such as “Court” and perform any predefined settings.

For example, when the mobile device detects a public information of “McLean Bible Church” then the device detects the keyword of “Church.” And then, the device displays icons related to the keyword specific predefined settings such as “Registered as Vibration Mode Place.”

1. A mobile device comprising following steps of
recognizing a current location,
searching a database either on cue or automatically based on at lease one predetermined search criteria set, and
displaying search result or automatically ask for further action or trigger into action.
